(19) United States
(12) Patent Application Publication
(10) Pub. No.: US 2006/0286502 A1
(43) Pub. Date: Dec. 21, 2006

(54) TEETH INDEXING DEVICE

(76) Inventor: Alexander SHOR, Bellevue, WA (US)

Correspondence Address: SPECKMAN LAW GROUP PLLC, 1201 THIRD AVENUE, SUITE 330, SEATTLE, WA, 98101, US

(21) Appl. No.: 11/424,522

(22) Filed: Jun. 15, 2006

Related U.S. Application Data
(60) Provisional application No. 60/691,700, filed on Jun. 17, 2005.

(51) Int. Cl. A61C 19/10

(52) U.S. Cl. 433/26

(57) ABSTRACT

A teeth indexing device for use in preparing dental prostheses is provided with a plurality of prefabricated denture teeth arranged in a dental arch-like configuration and connected to each other via a connector which may be integrated with the prefabricated denture teeth. Preferred teeth sizes and positions in the prosthesis can be determined using the device.

### CROSS REFERENCE TO RELATED APPLICATIONS

This application claims priority under 35 U.S.C. § 119(e) to U.S. Provisional Patent Application No. 60/691,700, filed Jun. 17, 2005.

### FIELD OF INVENTION

This invention generally relates to the preparation of dental prostheses in the field of prosthodontics, and particularly, this invention relates to a teeth indexing device.

### BACKGROUND OF THE INVENTION

There are a large number of edentulous and partially edentulous patients in the world. For example, in the United States, there are about 20 million edentulous patients. There are several potential treatment options for restoration of edentulous patients, as well as several restorative designs for denture prosthesis. Generally, complete denture prosthesis is the most common treatment modality for completely edentulous patients in order to restore the lost function of teeth and aesthetic appearance. Alternatively, endosseous dental implants can be utilized for support and retention of denture prostheses.

Fabrication of a complete denture prosthesis generally involves several sequential technical steps in the dental office and dental laboratory. One of these steps involves the determination of the appropriate spatial tooth position for the edentulous patient. Conventional techniques for the determination of tooth position generally include the “wax rim” technique and direct tooth placement method.

The “wax rim” technique involves the use of a denture base and a rim of wax. The denture base provides a support to the wax rim which is adjusted in the patient's mouth and serves as a guide/indicator for the position of the artificial teeth. The wax rim is adjusted three-dimensionally to the approximate tooth position in accordance with the acceptable standards of the dentate appearance. A patient's intraoral and facial landmarks are utilized as a guide in the process of the wax rim adjustment. For example, in the anterior-posterior plane, the wax rim is adjusted so that it provides an adequate upper lip support. In the vertical plane, the wax rim is adjusted using the position of the patient's lip at rest and during his/her smile. In addition, the midline of the face is transferred to the wax rim. Following this procedure, the mandibular wax rim is adjusted to fit in accordance with the maxillary rim, and both records are used in the process of bite recording. Once these relationships are established, the rims are sent to the dental laboratory where they are used to fabricate a “wax-try-in denture”, which is a prototype of the final denture. However, the “wax rim” technique has several disadvantages. It is time consuming and it is also a poor indicator for determining the size and position of the artificial teeth. Further, this technique does not facilitate communication with the dental laboratory. As a result, there is a high probability of tooth size and position errors.

The direct tooth placement technique involves the direct placement of artificial teeth into a record base. Teeth are placed using the aforementioned intraoral and facial landmarks. This approach usually involves placement of 6 maxillary anterior denture teeth. The direct tooth placement technique allows for a more predictable tooth placement compared to the “wax rim” technique, since it can be easily visualized. In addition, it facilitates the placement of the teeth in a laboratory. However, the direct tooth placement technique is extremely time-consuming in the clinic. In addition, this technique does not aid in tooth size determination.

U.S. Pat. No. 5,803,737 discloses a system for constructing temporary bridges to fill edentulous spaces found between a pair of abutment teeth in a human mouth. The system contemplates selecting an appropriate prefabricated temporary bridge mold from a selection of pre-sized molds. The portion of the prefabricated temporary bridge mold which corresponds to the edentulous space and flanking abutment teeth is selected, and cut away and retained as a mold subsection. The mold subsection is then filled with acrylic mix, and placed on top of the edentulous space and flanking abutment teeth such that the flanking abutment teeth form hollowed cavities in the cast temporary bridge which is formed upon hardening of the acrylic mix. The hardened, cast temporary bridge is then removed from the mold subsection and, after adjustments are made, placed over the edentulous space and on top of the flanking abutment teeth. The hollowed cavities in the temporary bridge receive the abutment teeth, thus creating a firm anchoring to hold the temporary bridge in place.

U.S. Pat. No. 5,018,533 discloses a process for reducing the occurrence of apneic episodes in an edentulous person including the steps of determining a neuromuscularly balanced position of the temporal mandibular joint of the edentulous person and shaping an oral appliance to maintain the neuromuscularly balanced position during sleep. The oral appliance has upper and lower plates with opposing planar rest surfaces which maintain the jaw position and angle corresponding to the neuromuscularly balanced position.

U.S. Pat. No. 6,315,555 discloses a series of single use print holders for obtaining prints of the maxillary arch and the mandibular arch in edentulous patients. On the periphery, the print holders comprise a channel which surrounds the gingival crest, maintaining a certain gap between the surface of the print holder and the surface of the gum for the material for obtaining the prints. To favor stability, the print holder is provided with gingival supports and for better positioning it comprises a frond handle and projections. By selecting a suitably sized print holder among the ones in the series, the final print to realize the total prosthesis can be obtained directly without making a preliminary primary print.

U.S. Pat. No. 4,483,677 discloses a flexible clasp for removable mounting of a partial dental prosthesis to an abutment tooth. The clasp includes a retention arm formed to extend around at least a portion of the side of an abutment tooth to retain the prosthesis in an edentulous space. The retention arm is coupled to the prosthesis at a location in the edentulous space, preferably about one tooth width from the abutment tooth so as to cantilever support the retention arm for resilient lateral displacement with respect to the abutment tooth.

### SUMMARY OF THE INVENTION

A teeth indexing device for the determination of desired tooth size and position when preparing dental prostheses for the completely and partially edentulous patients is provided. The inventive teeth indexing device can provide more predictable techniques for dentists and dental laboratory personnel regarding the selection and placement of the appropriate artificial teeth, resulting in better aesthetics and function, and reduced treatment time in the fabrication of the denture prosthesis.

The inventive teeth indexing device is provided with a plurality of prefabricated denture teeth connected to each other, by way of a connector, in the configuration of a dental arch. In one embodiment, the connector between each prefabricated denture tooth is flexible in order to allow spatial changes in the dental arch configuration. In another embodiment, the connector between each prefabricated denture tooth is rigid or semi-rigid.

The prefabricated denture teeth may be constructed in various sizes and configurations similar to those of human teeth using anterior and posterior molds known in the art. In one embodiment, the prefabricated denture teeth are arranged in a dental arch-like configuration, and are connected by means of a flexible connector integrated with the prefabricated denture teeth. The connector is positioned in the interproximal contact area of each of the prefabricated denture tooth, and allows the teeth indexing device to flex, thereby permitting the arch to widen or narrow.

In another embodiment, the inventive teeth indexing device is provided with a plurality of prefabricated denture teeth that are arranged in a dental arch-like configuration, and are connected by means of a rigid, or semi-rigid, connector integrated with the prefabricated denture teeth. The connector is positioned in the interproximal contact area of each of the prefabricated denture tooth.

### BRIEF DESCRIPTION OF THE DRAWINGS

The present invention will be described in greater detail in the following detailed description, with reference to the accompanying drawing, wherein:

FIG. 1 shows a perspective view of an embodiment of a teeth indexing device of the present invention.

### DETAILED DESCRIPTION OF THE INVENTION

A teeth indexing device is provided for determining the preferred sizes and positions of teeth in a dental prosthesis for replacing missing teeth. The device is suitable for use on a patient's maxillary arch or mandibular arch. Generally, the inventive teeth indexing device is provided with a plurality of prefabricated denture teeth that are arranged generally in a dental arch-like configuration. The inventive teeth indexing device is further provided with a connector, integrated with the prefabricated denture teeth. The connector can be flexible, rigid, or semi-rigid. In embodiments where the inventive teeth indexing device is provided with a flexible connector, the teeth indexing device can be flexed, widened, and narrowed.

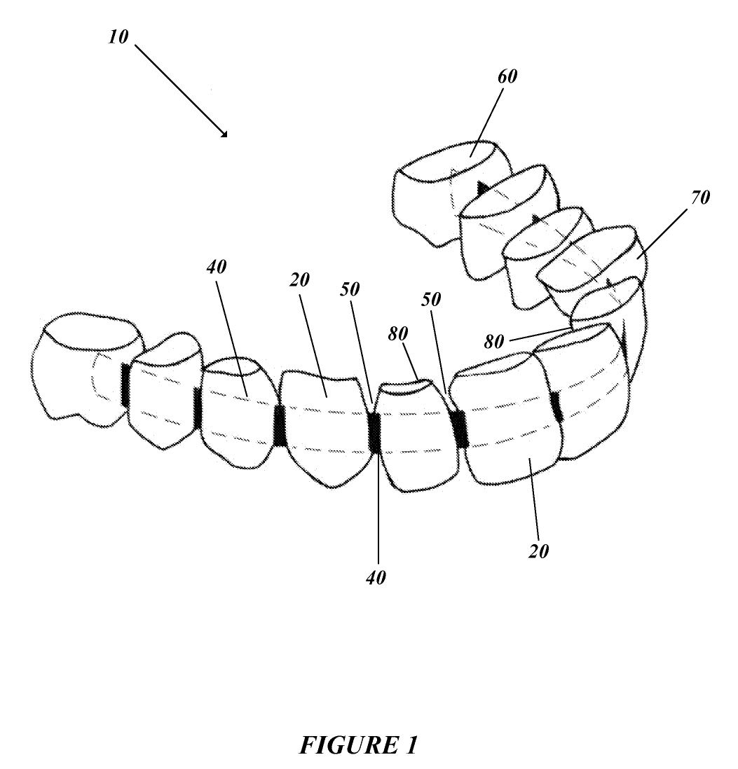

The inventive teeth indexing device comprises at least two prefabricated denture teeth. FIG. 1 shows an embodiment of the inventive teeth indexing device 10, which is provided with a plurality of prefabricated denture teeth 20. In the illustrated embodiment, teeth indexing device 10 is provided with about ten to about fourteen prefabricated denture teeth 20, although teeth indexing device 10 can be provided with more than fourteen or less than ten prefabricated denture teeth 20. In another embodiment, teeth indexing device 10 is provided with at least ten prefabricated denture teeth 20. In yet another embodiment, teeth indexing device 10 is provided with at least twelve prefabricated denture teeth 20. In still another embodiment, teeth indexing device 10 is provided with at least fourteen prefabricated denture teeth 20. In an alternative embodiment, teeth indexing device 10 is provided with at least sixteen prefabricated denture teeth 20. In another alternative embodiment, teeth indexing device 10 is provided with at least eight prefabricated denture teeth 20. The prefabricated denture teeth 20 may be constructed in various sizes and configurations similar to those of human teeth in maxillary/mandibular anterior and posterior molds known in the art, such as, but not limited to, central incisors, lateral incisors, canines, premolars, molars, and any combinations thereof. For example, the teeth indexing device 10 may be constructed so that the mesio-distal dimensions of the six maxillary denture teeth 20 is approximately 44 mm to 46 mm for a female, and approximately 48 mm to 52 mm for a male. In another embodiment, the teeth indexing device 10 may be constructed so that the mesio-distal dimensions of the six maxillary denture teeth 20 is 45 mm for a female, and 50 mm for a male. The prefabricated denture teeth 20 may be constructed of dental polymer materials, such as, but not limited to, methacrylate resin, acrylic resin, BIS-GMA type resin, and the like.

The plurality of prefabricated denture teeth 20 is collectively arranged in a dental arch-like configuration. The dental arch-like configuration may be achieved through the reproduction of a non-crowded arrangement of the human dentate arch. Human dentate arches with different mesio-distal dimensions of anterior teeth can be used as a prototype. The prototype can include, but is not limited to, the mesio-distal dimension of maxillary anterior teeth of 40 mm to 52 mm. The replica of this human arch in the form of a dental cast can be positioned on a flat metal plate and the facial outline of the anterior and posterior teeth is transferred to the metal plate. Prefabricated denture teeth 20 are secured onto the metal plate following the facial outline on the plate via any dental wax known in the art, and prefabricated denture teeth 20 are arranged according to the angulations of average human teeth.

Next, the metal plate secured with prefabricated denture teeth 20 is inverted and the gingival ⅓ of prefabricated denture teeth 20 is submerged into a putty of dental stone. After the dental stone is allowed to set, the plate is removed from prefabricated denture teeth 20, which are locked into the dental stone with the occlusal surfaces 60 and incisal surfaces 70 exposed.

In the embodiment shown in FIG. 1, a connector 40 is integrated with the prefabricated denture teeth 20 of the inventive teeth indexing device 10. Connector 40 extends from one end of the teeth indexing device 10 to the other end and may be constructed of flexible, semi-rigid, or rigid materials. In embodiments where teeth indexing device is provided a flexible connector, the teeth indexing device 10 can be flexed, widened, and narrowed. Materials suitable for constructing a flexible connector 40 include, but are not limited to, polymeric fibers, metal alloy wire, metallic strip, polymethylmethacrylate (PMMA), and the like. Materials that may be employed for constructing a rigid or semi rigid connector 40 include, but are not limited to, polymethylmethacrylate (PMMA), BIS-GMA type resin, polymeric resins, acrylic resins, and the like

A plurality of openings 50 is provided between each prefabricated denture tooth 20, in which a portion of connector 40 is exposed. In the embodiment illustrated in FIG. 1, each opening 50 measures about 0.5 mm from an edge of a prefabricated denture tooth 20 to an edge of an adjacent prefabricated denture tooth 20.

To integrate connector 40 with prefabricated denture teeth 20, a groove is provided in areas 60 of denture teeth 20, in centers of the posterior denture teeth (premolars and molars), or on the lingual areas 80 of the anterior teeth (incisors and canines). In the embodiment presented herein, the groove is about 1.5 mm to about 2.5 mm deep. To secure connector 40 to denture teeth 20, connector 40 is bent into the configuration of a dental arch, adjusted in length, and placed into the groove of denture teeth 20. After the placement of connector 40 into the groove of denture teeth 20, the openings 50 between denture teeth 20 are blocked-out with any dental wax known in the art. Dental polymer, such as acrylic resin, is subsequently poured into the groove and left undisturbed until it is hardened. After the dental polymer becomes hardened, the teeth indexing device 10 is removed from the dental stone, and any dental wax residues and excess dental polymer are removed.

In another embodiment, teeth indexing device 10 is not provided with a connector. In this embodiment, denture teeth 20 of teeth indexing device 10 are constructed of a polymeric material. In this embodiment, adjacent prefabricated denture teeth 20 may be connected directly to each other, thereby allowing the device 10 to flex, widen, and narrow without the need of a connector.

In yet another embodiment, multiple flexible connectors are employed in place of connector 40 to flexibly connect adjacent denture teeth 20. In this embodiment, an opening 50 is provided between adjacent denture teeth 20. A flexible connector is located in the opening 50 and connects one surface of a denture tooth 20 to a surface of another adjacent denture tooth 20, thereby allowing the teeth indexing device 10 to flex, widen, and narrow.

In still another embodiment, multiple rigid or semi-rigid connectors are employed to connect adjacent denture teeth 20. In this embodiment, an opening 50 is provided between adjacent denture teeth 20. A rigid or semi-rigid connector is located in the opening 50 and connects one surface of a denture tooth 20 to a surface of another adjacent denture tooth 20. In this embodiment, the teeth indexing device resembles a dental arch, with minimal ability to flex, widen, and narrow.

To use the inventive teeth indexing device on an edentulous patient, a conventional maxillary record base is first fabricated. Based on the patient's existing denture teeth dimensions and jaw size dimensions, or on average dimensions, a dentist selects a particular size of the teeth indexing device. The selected teeth indexing device is then secured onto a maxillary record base via any dental wax or putty of uncured polymer known in the art. The record base secured with the teeth indexing device is placed into the patient intraorally and the position of the teeth indexing device secured on the record base is modified accordingly. Once the position of the teeth indexing device is accepted and approved by the patient, the position of the teeth indexing device is further secured to the record base via dental wax or dental polymer. The position of the teeth indexing device placed in the mouth of the patient is then documented with photos of the patient's smile.

The teeth indexing device is sent to a dental laboratory and spatial position of the teeth in the indexing device is referenced on the dental articulator utilizing conventional techniques known in the art. The teeth indexing device is removed from the record base and artificial denture teeth are selected based on the dimensions provided by the teeth indexing device. The artificial denture teeth are then placed on the record base using the references on the dental articulator and returned to the dentist for a final evaluation.

Another embodiment of the teeth indexing device can also be utilized on partially edentulous patients having multiple missing anterior or posterior teeth. In this embodiment, sections of the teeth indexing device can be removed to fit the patient's edentulous areas for the determination of tooth size and position.

In still another embodiment, the teeth indexing device can be used for diagnostic purposes. In this embodiment, denture teeth of the teeth indexing device can be constructed of any radiopaque material known in the art. The device is placed in the patient's mouth and diagnostic radiographs are taken, which can aid in the determination of implant positions.

While certain embodiments of the present invention have been described, it will be understood that various changes could be made in the above constructions without departing from the scope of the invention. It is intended that all matter contained in the above description or shown in the accompanying drawing shall be interpreted as illustrative and not in a limiting sense.

I claim:

1. A teeth indexing device for determining preferred teeth sizes and positions in a dental prosthesis, comprising:
at least two prefabricated denture teeth arranged in a dental arch-like configuration, wherein the at least two prefabricated denture teeth are connected to each other by a connector that extends from one end of the teeth indexing device to a second end of the teeth indexing device.

2. The teeth indexing device of claim 1, wherein the connector has a configuration of a dental arch and is arranged in a groove provided in the prefabricated denture teeth.

3. The teeth indexing device of claim 1, wherein the connector is flexible, whereby the teeth indexing device can be flexed, and the arch-like configuration can be widened or narrowed.

4. The teeth indexing device of claim 3, wherein the connector is constructed of a material selected from the group consisting of: polymeric fibers, metal alloy wire, metallic strip, polymethylmethacrylate (PMMA), and combinations thereof.

5. The teeth indexing device of claim 1, wherein the connector is rigid or semi-rigid.

6. The teeth indexing device of claim 5, wherein the connector is constructed of a material selected from the group consisting of: polymethylmethacrylate (PMMA), BIS-GMA type resin, polymeric resins, acrylic resins, and combinations thereof.

7. The teeth indexing device of claim 1, wherein the teeth indexing device comprises at least ten prefabricated denture teeth.

8. The teeth indexing device of claim 1, wherein the teeth indexing device comprises at least twelve prefabricated denture teeth.

9. The teeth indexing device of claim 1, wherein the teeth indexing device comprises at least fourteen prefabricated denture teeth.

10. The teeth indexing device of claim 1, wherein an opening is provided between the at least two prefabricated denture teeth, and wherein a portion of the connector is exposed through the opening.

11. The teeth indexing device of claim 10, wherein the opening measures about 0.5 mm from a surface of the first prefabricated denture tooth to a surface of the adjacent second prefabricated denture tooth.

12. A teeth indexing device for determining preferred teeth sizes and positions in a dental prosthesis, comprising:
at least two prefabricated denture teeth arranged in a dental arch-like configuration, wherein an opening is provided between each adjacent prefabricated denture tooth, and wherein a flexible connector connects one surface of a first prefabricated denture tooth to a surface of a second adjacent denture tooth, thereby allowing the teeth indexing device to flex, widen, and narrow.

13. The teeth indexing device of claim 12, wherein the connector is constructed of a material selected from the group consisting of: polymeric fibers, metal alloy wire, metallic strip, polymethylmethacrylate (PMMA), and combinations thereof.

14. A teeth indexing device for determining preferred teeth sizes and positions in a dental prosthesis, comprising:
at least two prefabricated denture teeth arranged in a dental arch-like configuration, wherein an opening is provided between each adjacent prefabricated denture tooth, and wherein a rigid or semi-rigid connector connects one surface of a first prefabricated denture tooth to a surface of a second adjacent denture tooth.

15. The teeth indexing device of claim 14, wherein the connector is constructed of a material selected from the group consisting of: polymethylmethacrylate (PMMA), BIS-GMA type resin, polymeric resins, acrylic resins, and combinations thereof.
